(19) United States
(12) Patent Application Publication
(10) Pub. No.: US 2008/0055050 A1
(43) Pub. Date: Mar. 6, 2008

(54) Mobile file, indentification and security system device

(76) Inventor: Robert Brown, Warner Robins, GA (US)

Correspondence Address: Robert Brown Jr, 1612 Sweetwater Dr, Warner Robins, GA, 31088, US

(21) Appl. No.: 11/517,840

(22) Filed: Sep. 6, 2006

(51) Int. Cl. H04Q 5/22

(52) U.S. Cl. 340/10.41

(57) ABSTRACT

A mobile file, identification and security system device is disclosed with a particular architecture for allowing a card swiper/reader, vehicle computer, signal processor, signal receiver/transmitter, and receiver with display screen and speaker to transmit status/data-information i.e. a person name, vehicle tag and registration numbers, vehicle insurance effective dates, vehicle driver-owner-occupant name, vehicle make-model-color and associated business-commercial name and address affiliation, etc to any home, medical office, security gate check point, law enforcement/security vehicle, or remote location for verification, convenience, and identification and also for allowing a law enforcement/security officer portable handheld vehicle anti-theft device to jam/disable a vehicle engine-electronics system while in motion (being pursued) or parked. Intended user is the military and law enforcement, and any home, medical office, security gate checkpoint, or vehicle. The present systems key advantages provides a standoff identification-security system and a highway safety offensive-defensive weapon system tool/device for the military, law enforcement, and general public, and an assistive mobile/portable medical file/record and tool for emergency situations. The present systems key objectives are to support, improve and reinforce the Department of Homeland Security Highway Safety Initiatives and the War on Terror.

### TECHNICAL FIELD

This invention relates to home, medical office, vehicle, and audible security systems. More particularly, relates to a mobile file, identification and security system device with a card swiper/reader, signal processor, vehicle computer, display screen, portable handheld vehicle or vehicle equipped anti-theft engine-electronics system jammer/disabler, receiver/transmitter, and receiver with display screen and speaker attached thereon that is designed to provide the status/data-information i.e. name of a person, copy of medical file/record, vehicle tag and registration numbers, vehicle insurance effective dates, vehicle driver/owner-occupant name, vehicle make-model-color and associated business-commercial name and address affiliation, etc for allowing verification, convenience, and identification and use in any home, medical office, security gate check point, law enforcement/security vehicle, or remote location for the military, law enforcement, and general public.

### BACKGROUND OF THE INVENTION

Terrorism and terrorists have surfaced throughout the world, thus making a security gate check point, highway, home or work environment less safe. As a result, security screenings and verification checks have improved with electronics. A few key issues and disadvantages of the existing security systems: children and the elderly are routinely left home alone without parental/adult safeguards which documents or electronically records who and when a visitor arrives at the door and outputs electronic voice and text for identifying a visitor status/data-information to a child/any person for screening prior to opening the door; nationwide-worldwide, military and law enforcement/security officers are assaulted, injured, or killed at security check points by a highway terrorist/traffic violator-criminal while in the line of duty, and simultaneously law enforcement/security car chases-pursuits have increased and a few ending in catastrophic results causing harm and injury to innocent bystanders, thereby effecting increased automobile insurance costs; unscheduled or unwanted guests drives up/arrives in the driveway, and without advance notice the host is unprepared for meeting, greeting or managing the unscheduled or unwanted guest; an executive/guest is inconvenienced due to delays caused by a manual or physical check of vehicle and driver-occupant status/data-information at check points or headquarters facilities and other special gate locations which requires a speedy access or an unimpeded entrance; and people have medical problems/vehicle accidents while out of town/away from home which will require immediate availability/delivery of medical records and medical assistance. The present system device is assistive in resolving these disadvantages and key issues and satisfy and exceed all requirements.

### BRIEF SUMMARY OF THE INVENTION

In view of the above, the present invention is presented to accomplish several objectives and advantages such as the following:

It is an advantage and object of the present invention to provide law enforcement with an offensive-defensive standoff weapon system tool/device for allowing identification of a person and/or vehicle and driver-occupant status/data-information i.e. a person name, vehicle tag and registration numbers, vehicle insurance effective dates, vehicle driver/owner-occupant name, vehicle make-model-color and associated business-commercial name and address affiliation, etc electronically and while a vehicle is in motion (being pursued) or parked, and a general public and law enforcement highway offensive-defensive weapon system tool for allowing a law enforcement/security vehicle which performs car chases-pursuits with a remote control engine-electronics system jamming/disabling system device for protecting and shielding the public against unintended injury/harm and accidents in a car chase/pursuit and to improve a security officer survivability, safety and security while apprehending or giving a highway terrorist/traffic violator-criminal a citation or while routinely checking—verifying vehicle registration and insurance documents.

It is a further advantage and object of the present invention to provide a medical office, home, or vehicle with a card swiper/reader for allowing swiping/reading a programmed bar coded drivers license/data card which allows for a medical office to open/person to transport and possess a personal copy of medical file/record for timely/better medical treatment/diagnosis thus assisting doctors in saving a life during an emergency situation; vehicle to operate/switch-on power, automatically transmit vehicle and driver-occupant status/data-information, and reduce/prevent unauthorized vehicle use/car thefts; or child/elderly person/any person home security system with audible/visual receiver with display screen and speaker for allowing electronic voice and text output for allowing screening a visitor or vehicle status/data-information when home alone.

It is a further advantage and object of the present invention to provide instant notification of arrival and instant status/data-information of a person and/or vehicle and driver-occupant to a remote location for allowing enhanced security controls to eliminate using a time clock or time sheet for an employee for allowing a paperless system and an environmental impact to conserve a valuable resource—a tree.

It is yet a further advantage and object of the present invention to provide hosts, medical offices, homes, law enforcement/security officers, law enforcement/security vehicles, and security gate checkpoints with an electronic and automatic means for identifying and verifying the status/data-information of a person and/or vehicle and driver-occupant anytime a person is at a front, rear or side door of a home, or anytime a vehicle drives into a driveway, security gate check point, on a highway or parked.

It is yet another advantage and object of the present invention to effect home and automobile insurance costs reductions for allowing decreases in present and future rates of vehicle thefts, damages, and personal accidents and injuries with a law enforcement portable handheld vehicle anti-theft or security vehicle equipped system devices.

It is still a further advantage and object of the present invention to enhance environmental preservation/tree conservation and environmental impact for allowing a reduction/elimination of vehicle insurance identification and registration cards production, thereby avoiding using wood-paper products while simultaneously reducing associated automobile insurance company man-hours needed to perform research, write and manage personal injury and property claims, and assisting vehicle tag office and law enforcement personnel with faster customer service response times.

It is a further advantage and object of the present invention to provide a guest with a time savings avoiding delays from manual-physical verification checks at security gate checkpoints. Therefore, in comparison to a portable handheld remote control device which electronically locks/unlocks a vehicle door, the present invention claimed herein also will overcome the above situations and disadvantages.

### BRIEF DESCRIPTION OF THE SEVERAL VIEWS OF THE DRAWING(S)

FIG. 1, FIG. 2, FIG. 5, FIG. 6, and FIG. 7 illustrates the present mobile file, identification and security system device with signal receiver/transmitter, vehicle/medical office/home card swiper/reader, wiring harness, signal processor, law enforcement portable handheld vehicle anti-theft engine-electronics system jamming/disabling device or security vehicle equipped system, law enforcement/security vehicle display screen, vehicle computer, and home/medical office/security gate receiver with display screen and speaker attached thereon that can be used in any home, medical office, security gate check point, law enforcement/security vehicle, or remote location.

FIG. 1 illustrates a view of mobile file, identification and security system device which can be used in any law enforcement/security vehicle pursuit car.

FIG. 2 illustrates a view of mobile file, identification and security system device which can be used in any vehicle.

FIG. 3, FIG. 3A illustrates a view of law enforcement/security vehicles receiving status/data-information or transmitting engine-electronics jamming/disabling signals, FIG. 3B illustrates a view of a vehicle in a driveway, and FIG. 3C illustrates a view of a vehicle at a security gate checkpoint.

FIG. 4A, FIG. 4B, FIG. 4C, FIG. 4D, 4E, 4F, and 4G illustrates views of front and rear locations of a vehicle receiver/transmitter.

FIG. 5, FIG. 5A, FIG. 5B illustrates views of mobile file, identification and security system device signal processor which can be used in any vehicle, medical office,

FIG. 6, FIG. 6A, FIG. 6B, FIG. 6C illustrates top, side, and front views of mobile file, identification and security system device portable handheld remote control vehicle anti-theft device which can be used by law enforcement/security personnel.

FIG. 7 illustrates a view of mobile file, identification and security system device receiver with display screen and speaker which can be used in any home, medical office, law enforcement/security vehicle, security gate check point, or remote location.

### DETAILED DESCRIPTION OF THE INVENTION

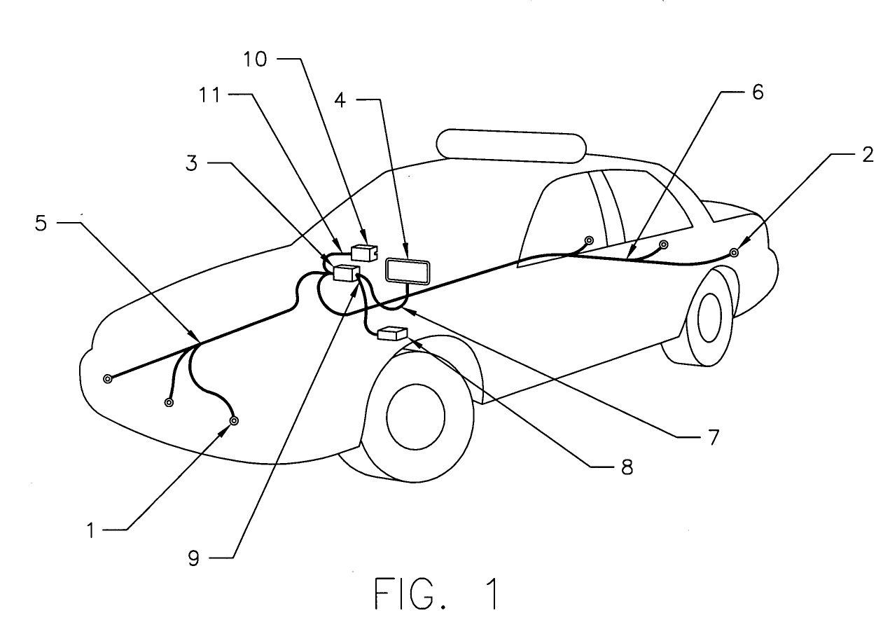

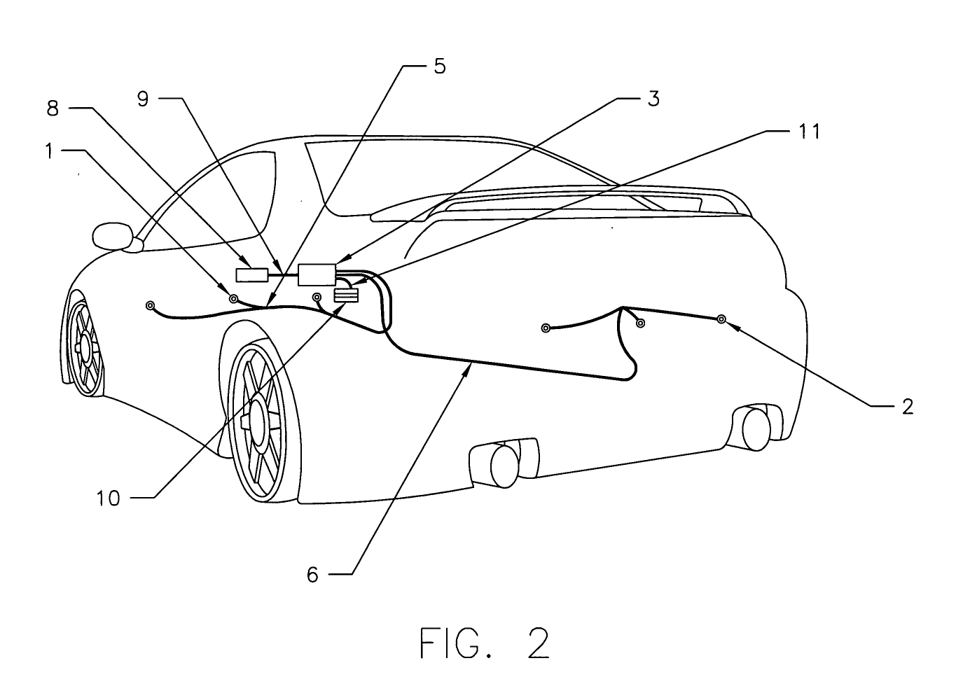

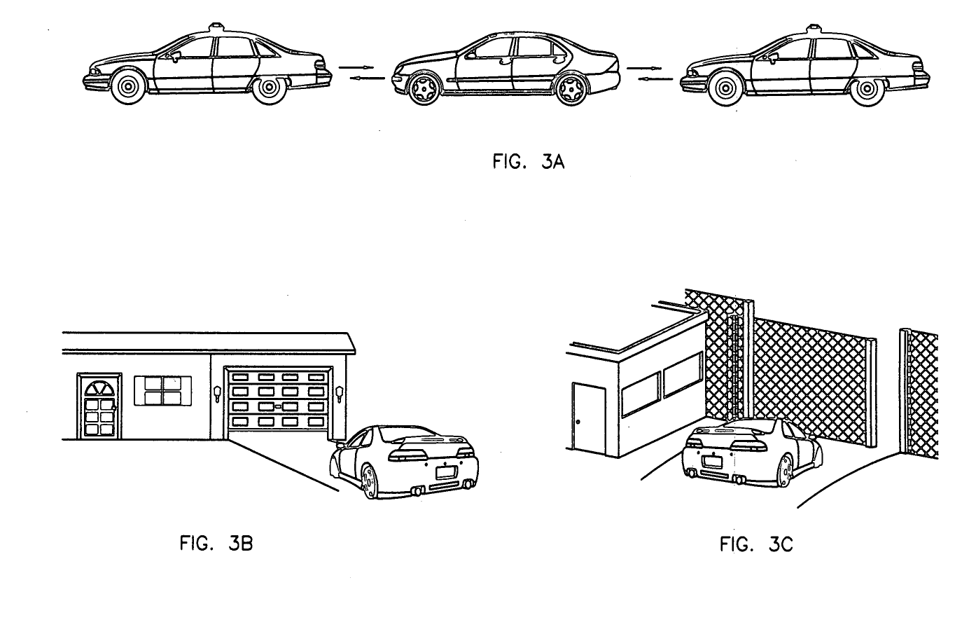

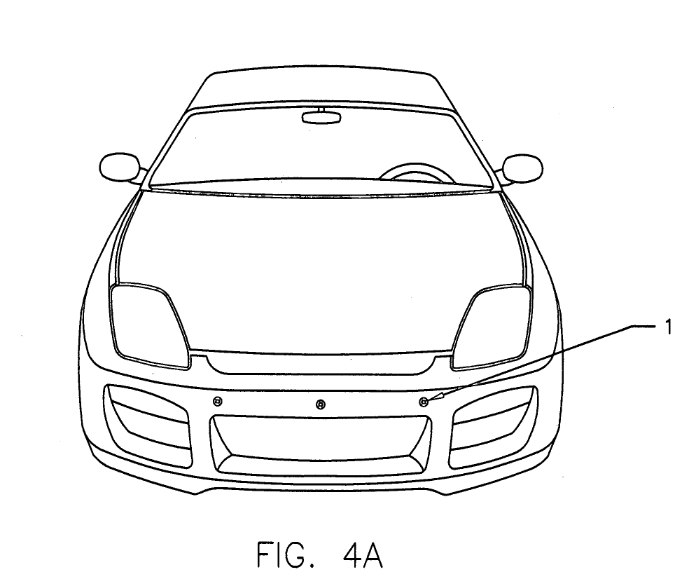

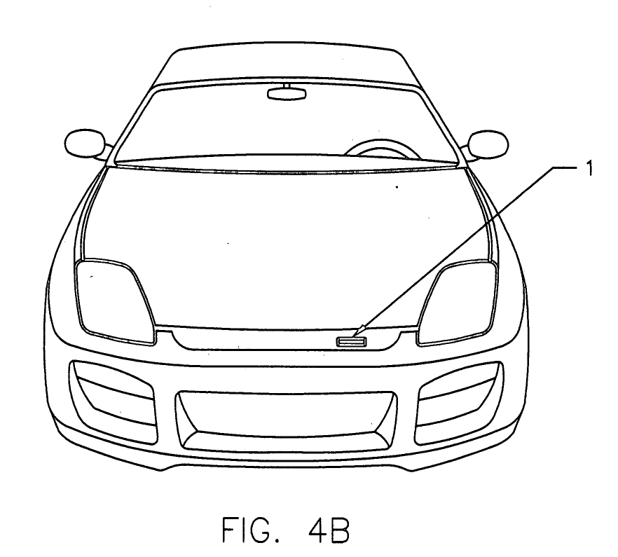

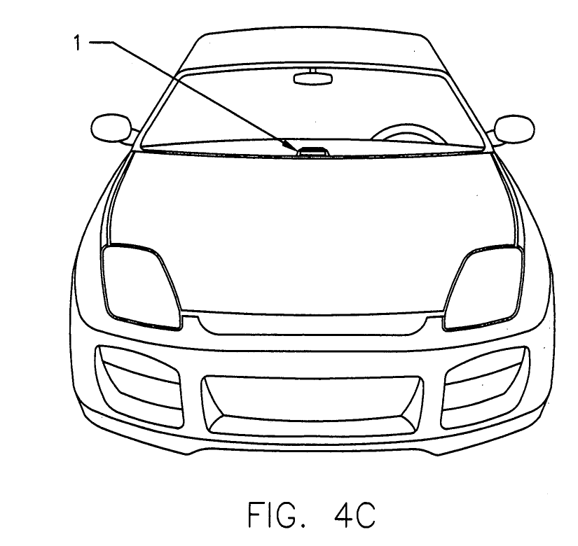

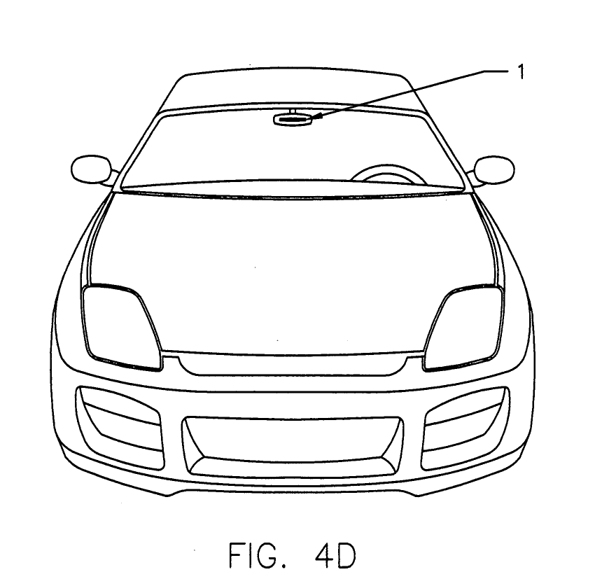

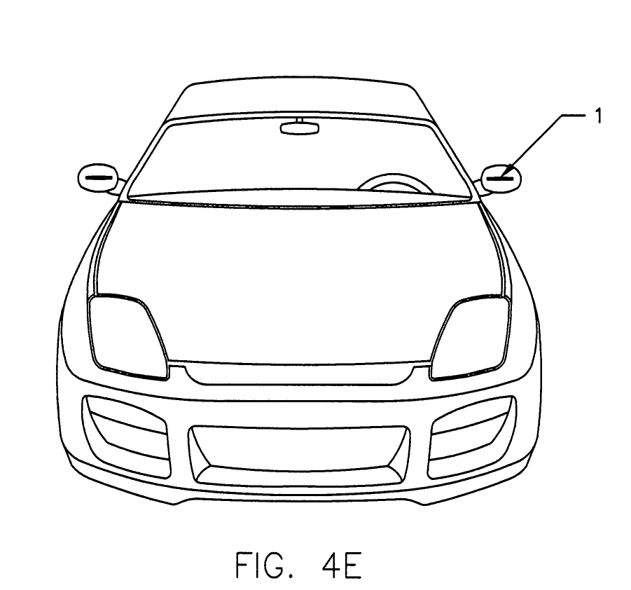

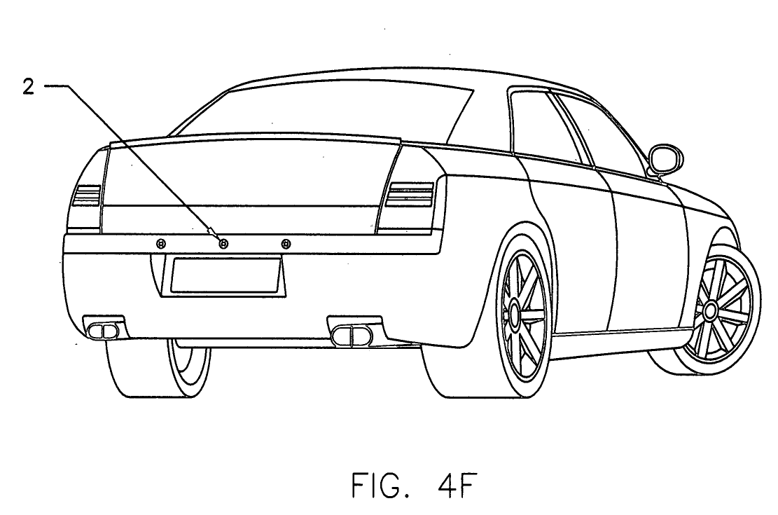

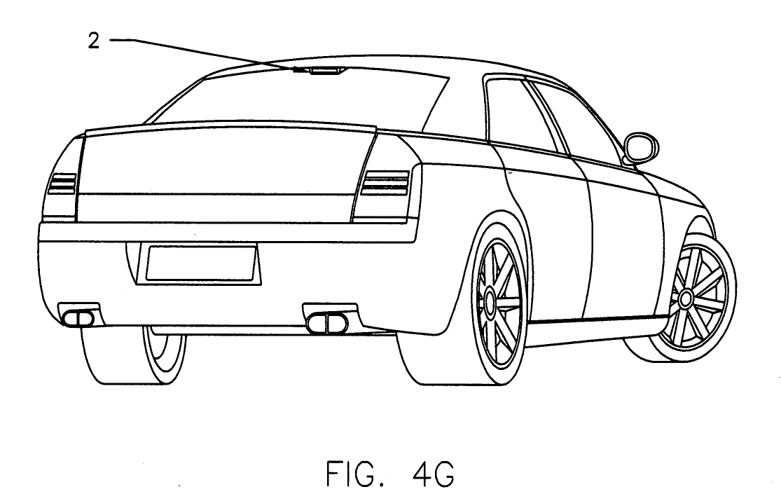

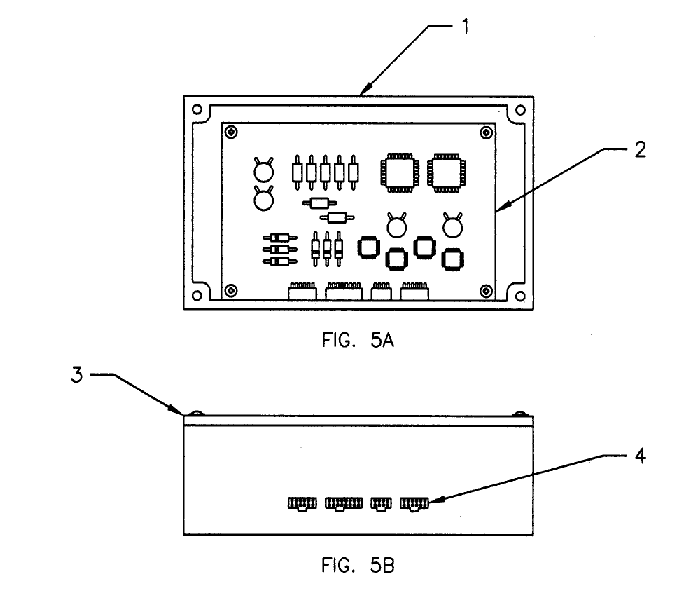

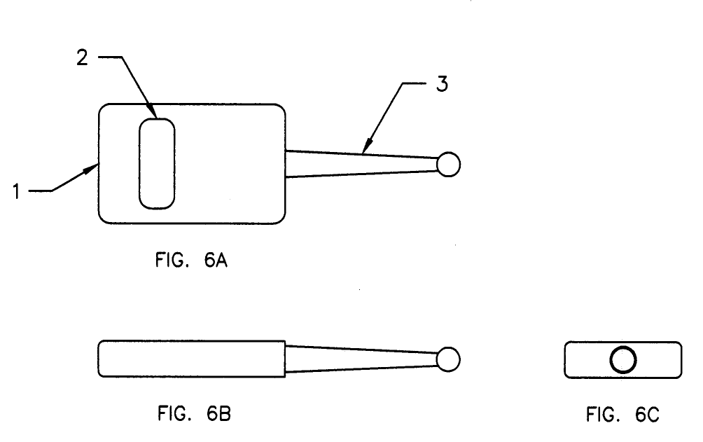

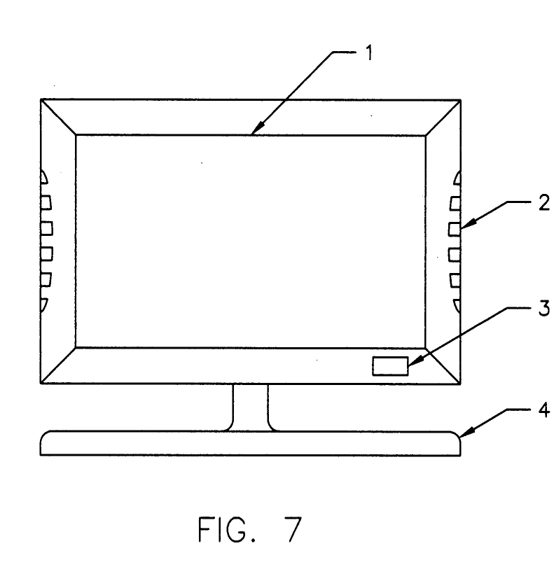

Referring to the drawings in greater detail, FIG. 1, FIG. 2, FIG. 3, FIG. 4, FIG. 5, FIG. 6, and FIG. 7 illustrates views of the embodiment of a mobile file, identification and security system device 1 that can be used in any vehicle, medical office, home, or remote location. The mobile file, identification and security system device 1 will typically comprise of a signal receiver/transmitter 1 and 2, FIG. 4A, FIG. 4B, FIG. 4C, FIG. 4D, FIG. 4E, FIG. 4F, or FIG. 4G, wiring harness 5, 6, 7, 9, and 11 signal processor 3 and FIG. 5, law enforcement portable handheld vehicle anti-theft engine-electronics system jamming/disabling device FIG. 6, law enforcement/security vehicle display screen 4, vehicle computer 8, vehicle/medical office/home card swiper/reader 10 and receiver FIG. 7 with display screen and speaker attached thereon that can be used in any home, medical office, security gate check point, vehicle, or remote location.

FIG. 1 illustrates a parts breakdown of a mobile file, identification and security system device 1 for use in any law enforcement/security vehicle for allowing vehicle card swiper/reader 10 to swipe/read a programmed bar coded drivers license card/electronics data card for allowing operating/switching-on law enforcement/security vehicle and attaches to vehicle computer 8 for allowing vehicle usage monitoring attaches to wiring harness 5, 6, 7, 9 and 11 for allowing power access attaches to receiver/transmitter 1, 2, FIG. 4A, FIG. 4B, FIG. 4C, FIG. 4D, FIG. 4E, FIG. 4F, and FIG. 4G attaches to front and rear of vehicle for allowing transmitting engine-electrical system jamming/disabling signal or receiving status/data-information signal to/from any vehicle attaches to signal processor 3 for allowing signal to output on and attaches to security vehicle display screen 4 for allowing status/data-information with electronic voice and text output.

FIG. 2 illustrates parts breakdown of a vehicle mobile file, identification and security system device 1 with card swiper/reader 10 for allowing operating/switching-on with swiping/reading a programmed bar coded drivers license card/data card and transmitting status/data-information i.e. transmitting vehicle tag and registration numbers, vehicle insurance effective dates, vehicle driver/owner-occupant name, vehicle make-model-color and associated business/commercial name and address affiliation, etc to home, security gate checkpoint, law enforcement/security vehicle or remote location receiver with display screen and speaker FIG. 7 which allows for audible/electronic voice and visual/text output attaches to vehicle computer 8 for allowing vehicle and driver-occupant status/data-information to flow/process to signal processor 3 attaches to wiring harness 5, 6, 7, 9 and 11 for allowing power access attaches to vehicle receiver/transmitter 1, 2, FIG. 4A, FIG. 4B, FIG. 4C, FIG. 4D, FIG. 4E, FIG. 4F, or FIG. 4G located on front and rear bumpers, dash, mirror, break light, etc for allowing transmitting status/data-information and jamming/disabling a vehicle engine-electronics system while in motion (being pursued) or parked.

FIG. 3, FIG. 3A illustrates view of a vehicle for allowing transmitting vehicle and driver-occupant status/data-information i.e. vehicle tag and registration numbers, vehicle insurance effective dates, vehicle driver/owner-occupant name, vehicle make-model-color and associated business-commercial name and address affiliation, etc or for allowing law enforcement/security vehicles to transmit a signal to jam/disable a vehicle engine-electronics system while in motion, FIG. 3B illustrates system device 1 vehicle in driveway for allowing transmitting the status/data-information to home receiver FIG.7 with display screen and speaker, and FIG. 3C illustrates vehicle system device at security gate checkpoint for allowing a vehicle to transmit status/data-information to security gate receiver FIG. 7 with display screen and speaker for verification, convenience, and identification to a security gate check point entrance.

FIG. 4A, FIG. 4B, FIG. 4C, FIG. 4D, FIG. 4E, FIG. 4F, and FIG. 4G illustrates mobile file, identification and security system device 1 signal receiver/transmitter 1 and 2 attaches to front bumper, grill, dash, mirrors, and break light for allowing status/data-information transmitting to a home, security gate, security officer vehicle, or remote location receiver FIG. 7 with display screen and speaker for verification, convenience, and identification and for allowing a security officer portable handheld vehicle anti-theft device FIG. 6 or security vehicle equipped system to electronically jam/disable a vehicle engine-electronics system while in motion (being pursued) or parked by remote controls to preclude further highway accidents and injuries by a highway terrorist/traffic violator-criminal.

FIG. 5, FIG. 5A, FIG. 5B illustrates mobile file, identification and security system device 1 signal processor 3 which attaches to receiver/transmitter FIG. 1 1 and 2 and FIG. 2 1 and 2 attaches to vehicle computer 8 and/or security vehicle display screen 4 having housing structure 1, circuit card 2, and interface plug 4 for allowing a vehicle to process received status/data-information transmitted from a vehicle to a law enforcement/security vehicle or process received engine-electronics system jamming/disabling signals transmitted from law enforcement/security officer portable handheld vehicle anti-theft device FIG. 6, FIG. 6A, FIG. 6B, and FIG. 6C, or security vehicle display screen FIG. 1 4.

FIG. 6, FIG. 6A, FIG. 6B, FIG. 6C illustrates mobile file, identification and security system device 1 portable handheld vehicle anti-theft device for allowing law enforcement personnel to jam/disable an engine-electronics system by remote control button 2 and antennae 3. The portable handheld vehicle anti-theft device will jam/disable an engine-electronics system, initiate power surge to overload circuits, or shut down/off vehicle engine while in motion (being pursued) or parked.

FIG. 7 illustrates mobile file, identification and security system device 1 home, medical office, or security gate receiver with display screen 1 and speaker 2 for allowing status/data-information output with audio/electronic voice and visual/text, power access on/off button 3 attaches to stand 4.

I claim:

1. A mobile file, identification and security system device which transmits/transports the status/data-information i.e. a person name, medical file/record, vehicle tag and registration numbers, vehicle insurance effective dates, vehicle driver/owner-occupant name, vehicle make-model-color and associated business-commercial name and address affiliation, etc to any home, medical office, security gate check point, law enforcement/security vehicle or remote location for verification, convenience, and identification, and which jams/disables a vehicle engine-electronics system by remote controls while a vehicle is in motion (being pursued) or parked, comprising:
a) A mobile system device with law enforcement portable handheld vehicle anti-theft device or security vehicle system engine-electronics system jammer/disabler;
b) said mobile system device having vehicle signal receiver/transmitter attached thereon;
c) said mobile system device having home, medical office, or security gate receiver with display screen and speaker attached thereon;
d) said mobile system device having signal processor and vehicle computer attached thereon;
e) said mobile system device having home, medical office, or vehicle driver's license card/data card swiper/reader attached thereto;

2. A mobile system device, according to claim 1 the security vehicle engine-electronics system jamming/disabling system allows for signal processor to transmit for satellite connection and usage by remote controls thereon;

3. A mobile system device, according to claim 1 the security vehicle display screen allows for touch screen vehicle tag number and vehicle identification number input for processing to satellite for jamming/disabling a vehicle engine-electronics system by remote controls and status/data-information text and electronic voice output thereon.
